(19) United States
(12) Patent Application Publication
(10) Pub. No.: US 2004/0224115 A1
(43) Pub. Date: Nov. 11, 2004

(54) Static cling gift labels for containers and method for demarcating and decorating containers

(76) Inventors: Betsy M. Weissman, New York, NY (US); Marc Lawrence Weissman, New York, NY (US)

Correspondence Address: STEINBERG & RASKIN, P.C., 1140 AVENUE OF THE AMERICAS, 15th FLOOR, NEW YORK, NY, 10036-5803, US

(21) Appl. No.: 10/834,813

(22) Filed: Apr. 29, 2004

Related U.S. Application Data
(60) Provisional application No. 60/466,644, filed on Apr. 30, 2003.

(51) Int. Cl. B32B 9/00; B32B 33/00

(52) U.S. Cl. 428/40.1

(57) ABSTRACT

A gift label for a container, the gift label being made from a piece of material that is adapted to cling to a surface of the container by virtue of static electricity. A method for demarcating containers, the method including the step of providing a plurality of containers, providing a plurality of static cling marker labels, each one of said plurality of static cling marker labels being visually distinguishable from every other static cling marker label of said plurality of static cling marker labels, and applying to each container of said plurality of containers one of the plurality of static cling marker labels. A method for decorating containers, the method including the step of providing a plurality of containers, providing a plurality of static cling marker labels, each one of said plurality of static cling marker labels being visually similar or identical to every other static cling marker label of said plurality of static cling marker labels, and applying to each container of said plurality of containers one of the plurality of static cling marker labels.

### REFERENCE TO RELATED APPLICATION

This application claims the benefit of U.S. Provisional Application Ser. No. 60/466,644 filed Apr. 30, 2003.

### FIELD OF THE INVENTION

The present invention relates generally to static cling labels, and in particular, to a static cling gift label for bottles, glasses, cans, beverage containers or the like. The present invention also relates to a method for demarcating a plurality of beverage containers with static cling labels to thereby render each piece of said plurality of containers visually distinguishable from one another or to enhance their visual appearance.

### BACKGROUND OF THE INVENTION

Normally when a container of wine, liquor, beer or another liquid is purchased as a gift for another the container is either simply given to the recipient in unwrapped state or alternatively the container is wrapped in wrapping paper or the like and the wrapping paper is secured about the container by tying a ribbon or the like around the container.

When a container is presented as gift in an unwrapped state it makes the presentation thereof to the recipient seem rather ordinary and does not emphasize or enhance the festive occasion for which the container is being presented. When a container is presented in a wrapped state there are other inherent problems. The foremost of these problems is that the wrapping paper prevents the recipient from viewing the container. It is noted that wine afficionados derive a certain pleasure from the esthetic beauty of a full bottle of wine, the color and shape of the bottle, the color and hue of the wine contained within the bottle, the density of the fluid, all of these provide hints as to the nature and exploits of the wine. Consequently, to cover the bottle with wrapping paper is to deprive the recipient of these small, but significant, pleasures. Still another problem with presenting a bottle of wine in a wrapped state is that the gift giver must first wrap the bottle of wine before presenting it, which is somewhat inconvenient.

Another common problem associated with beverages is that often times at parties, where many people are drinking the same or same type (e.g. red wine) of beverage, from identical or similar glassware, it is difficult to remember which glass corresponds to a particular individual. The applicant is not aware of any known method involving a static cling label that enables an individual piece of glassware to be easily demarcated to thereby inform individuals to whom the glass belongs or decorated.

### OBJECTS AND SUMMARY OF THE INVENTION

It is therefore the object of the present invention to provide a gift label that enables a container to be presented as a gift, the gift label at the same time overcoming the drawbacks and shortcomings of the prior art techniques for presenting a container as gift.

It is another object of the present invention to provide a gift label that can be easily attached to a container or the like without adhesive, thereby permitting the easy removal of the gift label from the container.

It is a further object of the present invention to provide a gift label that when applied to a container conforms to the contours of the container and thus does not detract from the inherent esthetic appearance of the container.

It is yet another object of the present invention to provide a gift label that when attached to a container emphasizes the nature of the festive occasion for which the container is being presented without substantially concealing the container.

It is still another object of the present invention to provide a gift label that allows the recipient to easily remove the gift label to thereby view the container label.

Briefly, these and other objects are attained by providing a static cling gift label for containers or the like that can be easily applied to containers or the like and also easily removed therefrom. The static cling gift label preferably has indicia printed thereon that emphasizes the occasion for which the container is being presented.

It is another object of the present invention to provide a method that enables an individual container to be easily demarcated to thereby inform individuals to whom the glass belongs.

It is another object of the present invention to provide a method that enables an individual container to be easily decorated to thereby create a uniform look.

Thus, according to another aspect of the invention a method for demarcating containers is provided that informs individuals to whom the container belongs. The method for demarcating container includes the steps of providing a plurality of containers, providing a plurality of static cling marker labels, each one of said plurality of static cling marker labels being visually distinguishable from every other static cling marker label of said plurality of static cling marker labels; and applying to each container of the plurality of containers one of said plurality of static cling marker labels. In this manner when the plurality of static cling marker labels are applied to the plurality of containers, each container is visually distinguishable from every other container.

According to yet another aspect of the invention a kit for demarcating containers is provided, the kit including a plurality of static cling marker labels, each one of said static cling marker labels being structured and arranged to cling to a corresponding one of a plurality of containers, each one of the plurality of static cling marker labels being visually distinguishable from every other static cling marker label of said plurality of static cling marker labels. In this manner the plurality of static cling marker labels may be applied to the plurality of containers so that each container is visually distinguishable from every other container.

Thus, according to another aspect of the invention a method for decorating containers is provided. The method for demarcating container includes the steps of providing a plurality of containers, providing a plurality of static cling marker labels, each one of said plurality of static cling marker labels being visually similar or identical to every other static cling marker label of said plurality of static cling marker labels; and applying to each container of the plurality of containers one of said plurality of static cling marker labels. In this manner when the plurality of static cling marker labels are applied to the plurality of containers, each container is visually similar to every other container.

According to yet another aspect of the invention a kit for decorating containers is provided, the kit including a plurality of static cling marker labels, each one of said static cling marker labels being structured and arranged to cling to a corresponding one of a plurality of containers, each one of the plurality of static cling marker labels being visually similar or identical to every other static cling marker label of said plurality of static cling marker labels. In this manner the plurality of static cling marker labels may be applied to the plurality of containers so that each container is visually similar to every other container.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 is a top plan view of the static cling gift label according to the present invention;

FIG. 2 is a sectional view of the static cling gift label of FIG. 1 taken along line 2-2;

FIG. 3A is a schematic view of a wine bottle showing the static cling label of the present invention applied thereto;

FIG. 3B is a schematic view of the wine bottle shown in FIG. 3A with the static cling label removed therefrom;

FIG. 4 is a top plan view of a substrate to which markers are applied, the markers being employed in the method for demarcating containers according to the present invention;

FIG. 5 is a schematic view showing a piece of containers with the marker, employed in the method for demarcating containers according to the present invention, attached thereto;

FIG. 6 is a sectional view of the substrate and one of the markers shown in FIG. 4 taken along line 6-6;

FIG. 7 is a top plan view of a substrate to which markers are applied, the markers being employed in the method for demarcating containers according to the present invention;

FIG. 8 is a top plan view of a substrate to which markers are applied, the markers being employed in the method for demarcating containers according to the present invention;

FIG. 9 is a top plan view of a substrate to which markers are applied, the markers being employed in the method for demarcating containers according to the present invention;

FIG. 10 is a top plan view of a substrate to which markers are applied, the markers being employed in the method for decorating containers according to the present invention; and

FIG. 11 is a top plan view of a substrate to which markers are applied, the markers being employed in the method for decorating containers according to the present invention.

### DETAILED DESCRIPTION OF THE INVENTION

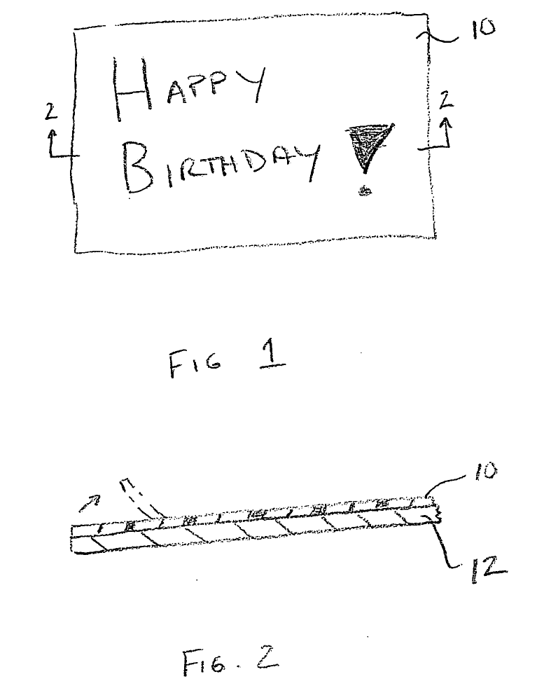

Referring now to the figures in which like reference characters designate identical or corresponding parts throughout the several views, and more particularly to FIGS. 1-3A, the static cling gift label according to the present invention is generally identified by the numeral 10.

The static cling gift label 10 is made from a static cling vinyl material. Preferably, the static cling gift label is made from a static cling vinyl manufactured by Transilwrap Company, Inc. under the name Trans-Flex-Cast tm. The labels may also be made of a polyvinyl chloride material and is manufactured by a calendering process that is well known in the art. Such a material is manufactured by GPA, Inc. and sold under the name ULTRA FILMS®. Static cling label materials of this type are well known in the art and thus no further explanation of these materials is required herein.

As shown in FIG. 1, the static cling gift label 10 is preferably pre-printed with indicia thereon, e.g. “Happy Birthday”, that emphasizes the occasion for which the container is being presented. Many other phrases, such as “Happy Anniversary”, “Congratulations”, “Merry Christmas”, etc., could be printed on the label by the manufacturer to thereby enable the consumer to select the appropriate label for the particular occasion being celebrated. It is also possible that the label could be produced in various shapes to emphasize the occasion being celebrated. For example, the gift label 10 could be produced in the shape of a birthday cake to thereby indicate that the bottle is being presented for a birthday.

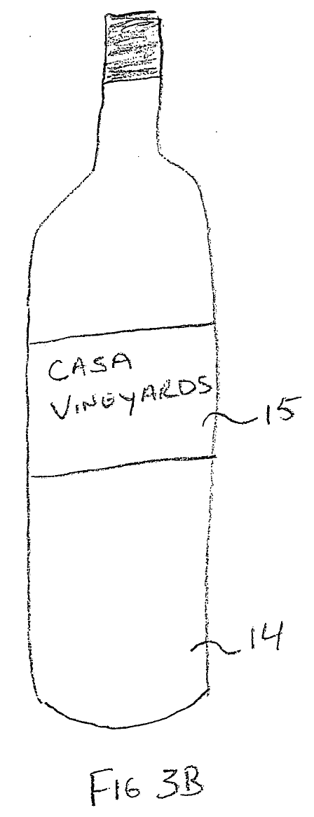

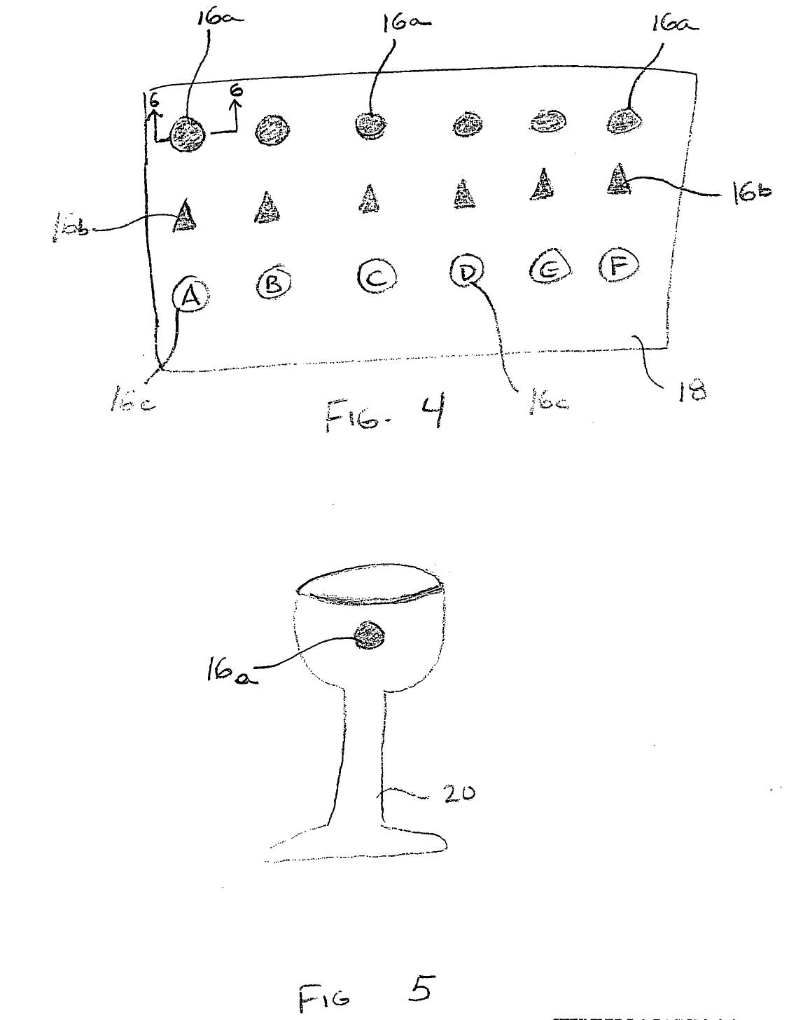

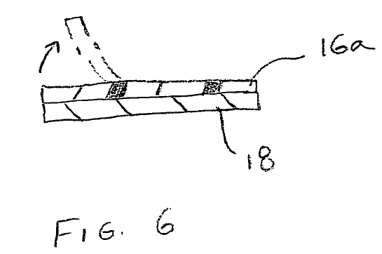

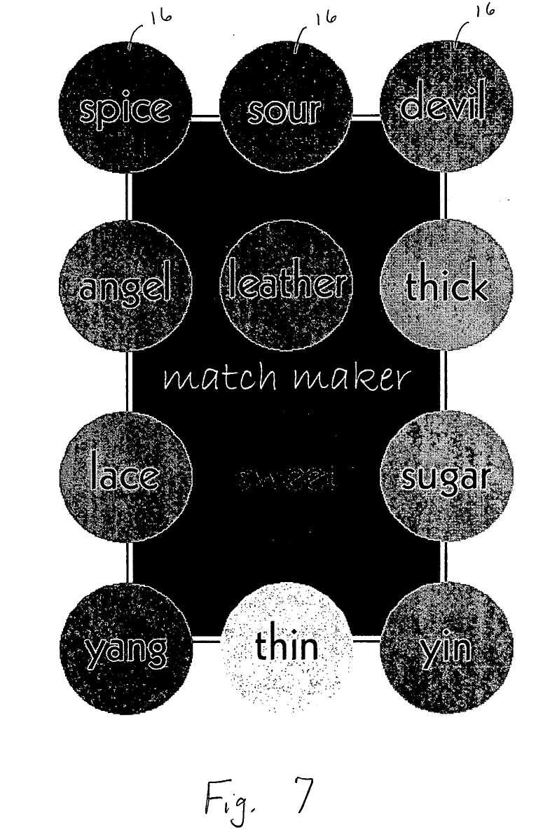

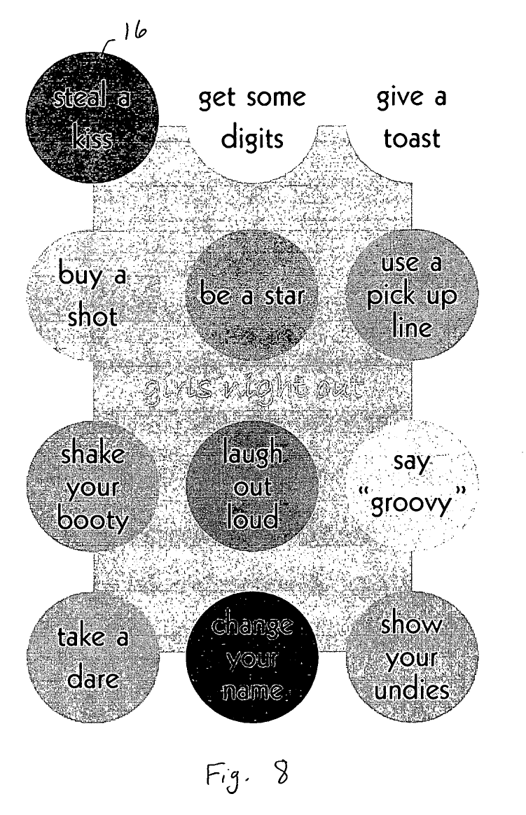

As shown in FIG. 3A, the static cling gift label 10 is applied directly to the container 14. As shown in FIG. 3A, when the static cling gift label 10 is applied to the container 14, the majority of the container 14 is still exposed and visible, unlike conventional wrapping techniques that conceal the entire container. Moreover, as shown in FIG. 3B the static cling gift label 10 can easily be removed to thereby permit the recipient to easily view the entire container including the container label 15. The gift label 10 preferably has dimensions of about 7″ wide by about 5″ long.

Since gift label 10 is made from a material that easily clings to various surfaces due to static electricity, the gift label 10 can be easily applied to the container 14 by simply placing the label 10 against the surface of the container 14. Thus, no adhesives or the like are required. Further, the gift label 10 can easily be removed from the container 14 by simply grasping the label 10 and removing it from the container 14.

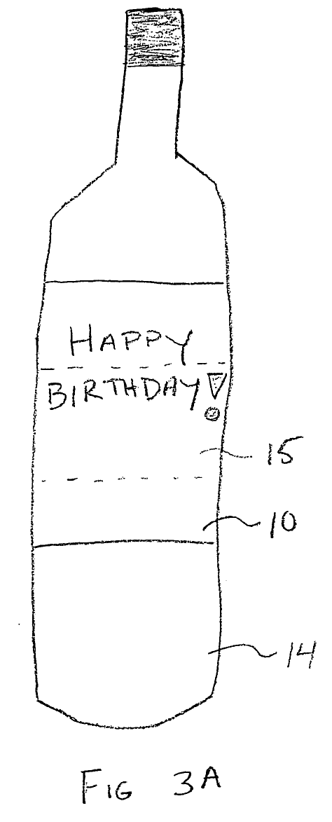

Preferably, as shown in FIG. 2, the gift label 10 would be sold initially applied to a substrate 12. In this manner, the gift label 10 would not inadvertently cling to surfaces until the gift label 10 is removed from the substrate 12 by the user, just prior to the application of the gift label 10 to the container 14. When ready for use, the gift label 10 could simply be removed, that is peeled, from the substrate 12 as shown in FIG. 2, and then applied to the bottle.

The gift labels 10 may also be used to to create a uniform look and color palette among many different containers by adhering a gift label 10 with decorative textures such as stripes, patterns or artistic images. Further, the gift labels 10 can be decorative in that they coordinate with a particular theme or event. For example, gift labels 10 with a New Years theme could be used on all containers at a New Years party.

The gift labels 10 may also be used to promote a business or event by displaying a particular logo or message among many containers. For example, a hotel chain could adhere a gift label 10 with their branding information on all containers presented to guests in their room.

Another example would be a concert event using the gift labels 10 to promote a band or future event by adhering the labels to beer or soda bottle sold to concertgoers.

The gift labels 10 may also be used for customization whereby the gift labels 10 could be used for a private event. For example, guests at a wedding would see bottles on their table and bottles they are served from with gift labels 10 adhered to them displaying a picture of the married couple, their monogram, etc.

The gift labels 10 may be used as a greeting card whereby the gift label 10 can be adhered to a bottle in lieu of purchasing a separate greeting card. For example, a Happy Birthday label can be adhered to a bottle instead of including a separate greeting card.

Although the use of the gift label 10 has been shown in the Figures in connection with a wine bottle it is possible that the label could also be applied to beer bottles, beer cans, liquor bottles, champagne bottle, jar, canister, glass, can, bottle, plastic cup or plastic bottle, or any other type of container and the like.

In this regard, for these various applications, the specific dimensions of the label may be varied to be suitable for the particular use. Although the static cling gift label according to present invention has been shown and described above, it will be apparent to those having ordinary skill in the art that a number of changes, modifications or alterations may be made, none of which depart from the spirit of the present invention. All such changes, modifications or alterations should therefore be seen as within the scope of the present invention.

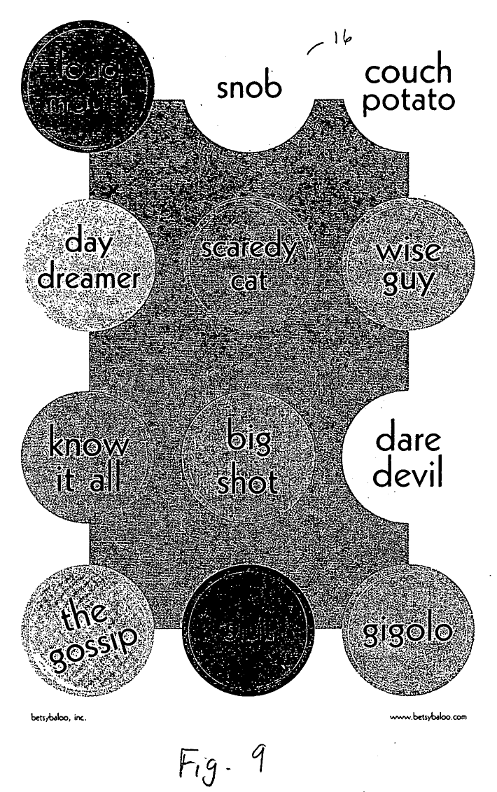

Reference is now made to FIGS. 4-6. FIG. 4 shows a plurality of markers for demarcating containers. These containers may be any type of container such as a glass, cup, can or bottle. Each of the markers being generally referred to by the reference numeral 16a, 16b or 16c. As shown, each of the markers 16a, 16b and 16c are initially attached to a substrate 18. Each of the markers 16a, 16b and 16c are made from a static cling label material of the type discussed above. The markers 16a, 16b and 16c are sold initially attached to the substrate material 18 to thereby prevent markers from inadvertently clinging to surfaces prior to use. In addition, the plurality of markers 16a, 16b and 16c are preferably sold in a “set” or “kit”, that is, a plurality of markers 16a, 16b and 16c are preferably sold together in a manner similar to that depicted in FIG. 4.

Each of the markers 16a, 16b and 16c is visually distinguishable from every other marker in the set. For example, in FIG. 4, each of the solid circular markers 16a would be different colors so that they are visually distinguishable from one another. Likewise, each of the solid triangular markers 16b would be different colors to make each of these markers visually distinguishable from one another. Similarly, each of the markers 16c would have a different letter printed thereon so that each of these markers are visually distinguishable from one another. Various variations on this theme are possible, however it is critical that each of the markers within a given set be visually distinguishable from all of the other markers within the set.

In use, as shown in FIG. 6, a marker 16a, 16b or 16c is first removed from the substrate 18 and then applied to a container which in this example is a piece of glassware 20 as shown in FIG. 5. In this same manner, each of a plurality of pieces of glassware 20 can be individually marked with a different marker. Since every marker is visually distinguishable from every other marker in the set, a plurality of pieces of glassware can be marked so each piece of glassware can be individually identified.

The above described method for demarcating glassware can be used at parties, for example, so that each individual know which is his or her glass. This is particularly helpful when many different individuals are drinking the same or same type (e.g. red) of wine, from identical or similar glassware. Games: whereby the labels could be used as a game at a party or get-together. For example, guests would be given a particular label for their glass at a party and the game would be to seek out the guest with the matching or coordinated label; “Sugar” would seek out “Spice”, “Leather” would seek out Lace” as shown in FIG. 7. Another example is having guests at a party or get-together acting out the actions indicated by their label; “tell a lie”, “laugh out loud”, “steal a kiss” as shown in FIG. 8. Another example is having guests act out the personality on their label; “shy”, “sexy”, “loud mouth” as shown in FIG. 9.

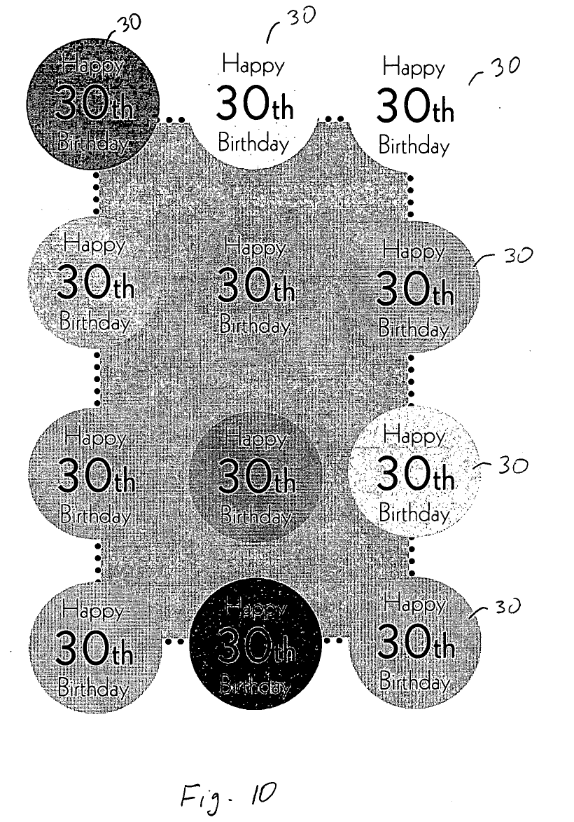

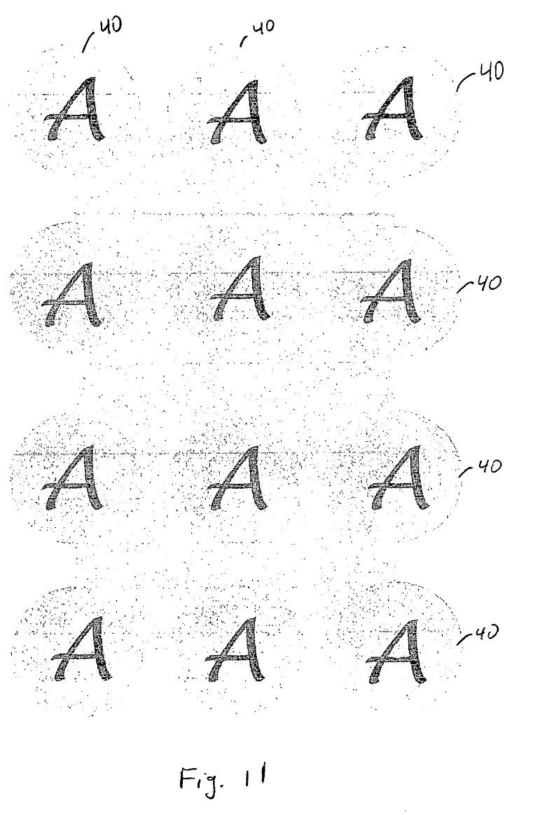

Reference is now made to FIGS. 10-11. FIG. 10 shows a plurality of similar or identical labels 30 for demarcating containers. These containers may be any type of container such as a glass, cup, can or bottle as stated above. Each of the labels being generally referred to by the reference numeral 30. Each of the labels 30 are made from a static cling label material of the type discussed above. In addition, the plurality of labels 30 are preferably sold in a “set” or “kit”, that is, a plurality of labels 30 are preferably sold together in a manner similar to that depicted in FIG. 10.

Each of the labels 30 is visually similar or identical to every other marker in the set. They may have the same lettering as labels 30 but have a different background color, or they may be exactly identical as shown by labels 40 in FIG. 11. Various variations on this theme are possible, however it is critical that each of the markers within a given set be visually similar or identical to all the other markers within the set.

In use, the labels 30 are placed on containers as shown in FIG. 6. In this same manner, each of a plurality of pieces of glassware 20 can be marked with a similar marker. Since every marker is visually similar to every other marker in the set, a plurality of pieces of glassware can be marked so each piece of glassware can be seen as part of a group.

The above described method can be used at parties, for example, as a decorative accent whereby the labels 30 can be used as decoration among many different glasses by adhering labels 30 with decorative textures such as stripes, patterns or artistic images or messages. Further, the labels 30 can be decorative in that they coordinate with a particular theme or event. For example, labels with a Happy Birthday or a sports team logo could be applies to the glasses, cans and cups at a birthday party or the Superbowl.

The labels could be used as a game at a party or get-together. For example, guests would be given a particular label for their glass at a party and the game would be to seek out the guest with the matching or coordinated label; “Sugar” would seek out “Spice”, “Leather” would seek out Lace” as shown in FIG. 7. Another example is having guests at a party or get-together acting out the actions indicated by their label; “tell a lie”, “laugh out loud”, “steal a kiss” as shown in FIG. 8. Another example is having guests act out the personality on their label; “shy”, “sexy”, “loud mouth” as shown in FIG. 9.

As shown in FIG. 11, the labels 40 can be used to promote a business or event by displaying a particular logo or message among many glasses, cans or cups. For example, an airline could adhere a label 40 with their branding information on all cups served to passengers. Another example would be a sports stadium using the labels 40 to promote their team by adhering the labels 40 to all beer and soda cups, plastic bottles sold a sporting event.

The labels 40 could be used for a private event. For example, guests at a wedding would have glasses with labels 40 adhered to them displaying the initial of the married couple or the date of the wedding.

Although the method for demarcating and decorating containers according to the present invention has been shown and described above, it will be apparent to those having ordinary skill in the art that a number of changes, modifications or alterations may be made, none of which depart from the spirit of the present invention. All such changes, modifications or alterations should therefore be seen as within the scope of the present invention.

We claim:

1. A gift label for a container comprising:
a piece of material that is adapted to cling to a surface of a container by virtue of static electricity.

2. The gift label according to claim 1, wherein said piece of material has printed thereon indicia that emphasizes a celebratory event.

3. The gift label according to claim 1, wherein said piece of material is polyvinyl chloride.

4. The gift label according to claim 1, further comprising a substrate to which the piece of material is initially attached, said piece of material being manually removable from said substrate prior to an attachment of said piece of material to a container.

5. A method for presenting a container as a present comprising the steps:
applying a static cling gift label to a container; and
presenting said container with said static cling gift label applied thereto as a gift to a recipient.

6. The method according to claim 5, further comprising:
printing on said label indicia that is indicative of a celebratory occasion for which said container is being presented.

7. The method according to claim 5, further comprising:
removing said gift label from a substrate material prior to applying said label to said container.

8. A method for demarcating containers comprising the steps of:
providing a plurality of containers;
providing a plurality of static cling marker labels, each one of said plurality of static cling marker labels being visually distinguishable from every other static cling marker label of said plurality of static cling marker labels;
applying to each container of said plurality of containers one of said plurality of static cling marker labels;
whereby when said plurality of static cling marker labels are applied to said plurality of containers, each container is visually distinguishable from every other container.

9. The method according to claim 8, wherein each one of said plurality of static cling marker labels is a different color.

10. The method according to claim 8, wherein each one of said plurality of static cling marker labels has indicia printed thereon to thereby make each static cling marker label visually distinguishable from every other static cling marker label.

11. The method according to claim 8, further comprising the step of:
removing each one of said plurality of static cling marker labels from a substrate material prior to applying said static cling marker to said container.

12. The method according to claim 8, wherein each of said static cling marker labels is made from a material that is adapted to cling to a surface of said container by virtue of static electricity.

13. The method according to claim 12, wherein each of said static cling marker labels is made from polyvinyl chloride.

14. A kit for demarcating containers comprising:
a plurality of static cling marker labels, each one of said static cling marker labels being structured and arranged to cling to a corresponding one of a plurality of containers, and each one of said plurality of static cling marker labels being visually distinguishable from every other static cling marker label of said plurality of static cling marker labels;
whereby when said plurality of static cling marker labels are applied to said plurality of containers, each container is visually distinguishable from every other container.

15. The kit according to claim 14, wherein each one of said plurality of static cling marker labels is a different color.

16. The kit according to claim 14, wherein each one of said plurality of static cling marker labels has indicia printed thereon to thereby make each static cling marker label visually distinguishable from every other static cling marker label.

17. The kit according to claim 14, further comprising:
a substrate material to which each of said static cling marker labels is initially removably attached, said substrate being structured and arranged to enable said static cling marker labels to be removed therefrom prior to applying said static cling marker labels to said containers.

18. The kit according to claim 14, wherein each of said static cling marker labels is made from a material that is adapted to cling to a surface of said container by virtue of static electricity.

19. The kit according to claim 18, wherein each of said static cling marker labels is made from polyvinyl chloride.

20. A method for decorating containers comprising the steps of:
providing a plurality of containers;
providing a plurality of static cling marker labels, each one of said plurality of static cling marker labels being visually similar or identical to every other static cling marker label of said plurality of static cling marker labels;
applying to each container of said plurality of containers one of said plurality of static cling marker labels;
whereby when said plurality of static cling marker labels are applied to said plurality of containers, each container is visually similar to every other container.

21. The method according to claim 20, wherein each one of said plurality of static cling marker labels is the same color.

22. The method according to claim 20, wherein each one of said plurality of static cling marker labels has indicia printed thereon to thereby make each static cling marker label visually similar to every other static cling marker label.

23. The method according to claim 20, further comprising the step of:
removing each one of said plurality of static cling marker labels from a substrate material prior to applying said static cling marker to said container.

24. The method according to claim 20, wherein each of said static cling marker labels is made from a material that is adapted to cling to a surface of said container by virtue of static electricity.

25. A kit for decorating containers comprising:
a plurality of static cling marker labels, each one of said static cling marker labels being structured and arranged to cling to a corresponding one of a plurality of containers, and each one of said plurality of static cling marker labels being visually similar or identical to every other static cling marker label of said plurality of static cling marker labels;
whereby when said plurality of static cling marker labels are applied to said plurality of containers, each container is visually similar to every other container.

26. The kit according to claim 25, wherein each one of said plurality of static cling marker labels is the same color.

27. The kit according to claim 25, wherein each one of said plurality of static cling marker labels has indicia printed thereon to thereby make each static cling marker label visually similar to every other static cling marker label.

28. The kit according to claim 25, further comprising:
a substrate material to which each of said static cling marker labels is initially removably attached, said substrate being structured and arranged to enable said static cling marker labels to be removed therefrom prior to applying said static cling marker labels to said container.

29. The kit according to claim 25, wherein each of said static cling marker labels is made from a material that is adapted to cling to a surface of said container by virtue of static electricity.

30. The kit according to claim 25, wherein each of said static cling marker labels is made from polyvinyl chloride.
